(19) United States
(12) Patent Application Publication
(10) Pub. No.: US 2020/0346987 A1
(43) Pub. Date: Nov. 5, 2020

(54) Agricultural Composition Containing Si Clay

(71) Applicant: HELENA AGRI-ENTERPRISES, LLC, Collierville, TN (US)

(72) Inventors: Chris Albright, Jensen Beach, FL (US); Curt MATHEWS, Lake Placid, FL (US); John POLHILL, Clewiston, FL (US)

(21) Appl. No.: 16/878,100

(22) Filed: May 19, 2020

Related U.S. Application Data
(63) Continuation-in-part of application No. 16/681,010, filed on Nov. 12, 2019.
(60) Provisional application No. 62/776,560, filed on Dec. 7, 2018.
(60) Provisional application No. 62/767,743, filed on Nov. 15, 2018.

(51) Int. Cl. C05D 9/00; C05G 3/00; C05G 5/12

(52) U.S. Cl. CPC C05D 9/00; C05G 5/12; C05G 3/00

(57) ABSTRACT

A process of treating a plant which by applying an agricultural composition which contains Si clay granules or powders wherein the composition is applied in an amount from about 150 pounds to about 4,000 pounds per acre.

### CROSS-REFERENCE TO RELATED APPLICATIONS

This application is a continuation-in-part to U.S. Ser. No. 16/681,010 filed Nov. 12, 2019 ('010 application). The '010 application is incorporated by reference in its entirety for all useful purposes. The '010 application claims benefit to U.S. Provisional application No. 62/776,560 filed Dec. 7, 2018 and U.S. Provisional application No. 62/767,743 filed Nov. 15, 2018 and which are both incorporated by reference in their entirety for all useful purposes.

### BACKGROUND OF THE INVENTION

Silicon “Si” is considered a “functional” or “beneficial” (rather than essential) plant nutrient. In Florida, Si amendments may increase cane and sugar yields as much as 25% and may support more successful ratoon crops.

Adding a soil amendment, also called a soil conditioner, helps improve plant growth and health. The type of amendment or amendments added depends on the current soil composition, the climate, and the type of plant. Some of the various amendments include:
1. Lime (makes soil less acidic)
2. Fertilizers for plant nutrients (i.e. manure, peat, or compost)
3. Materials for water retention (i.e. clay, shredded bark, or vermiculite)
4. Gypsum (releases nutrients and improves structure)
5. Clay fallows water to reach the plant root).

Various elements, which are normally drawn from the soil, are known to be essential to plant nutrition. These elements include: nitrogen (N), phosphorus (P), potassium (K), sulfur (S), calcium (Ca), magnesium (Mg), iron (Fe), manganese (Mn), copper (Cu), cobalt (Co), zinc (Zn), boron (B), nickel (Ni), molybdenum (Mo), and chlorine (Cl). Of these elements, nitrogen, phosphorus, potassium, sulfur, calcium, and magnesium are needed by plants in relatively large quantities and are therefore called macronutrients. The remaining members of the group (iron, manganese, copper, cobalt, zinc, boron, nickel, molybdenum, and chlorine) are known as micronutrients since they are required in very small amounts for plant growth.

Supplying a plant's major nutrient needs (nitrogen, phosphorus, potassium—N—P—K) is most effective and economical via soil application. However, foliar application has proven to be an excellent method of supplying plant requirements for secondary macronutrients (sulfur, calcium, magnesium) and micronutrients (carbon (C), hydrogen (H), and oxygen (O), nitrogen (N), phosphorus (P) and potassium (K),while supplementing N—P—K needs for short and/or critical growth stage periods. Additionally, the so called micronutrients, also commonly provided by mineral fertilizers are: boron (B), chlorine (Cl), copper (Cu), iron (Fe), manganese (Mn), zinc (Zn) and molybdenum (Mo). Foliar application refers to the application of plant nutrients to above-ground plant parts. Foliar fertilization programs prolong the fertilizing application period, providing a continuous supply of nutrients when crop demand is at a maximum, and can be an economical way to boost yield.

In fertilization programs, sulfate metal salts (e.g., zinc sulfate, manganese sulfate, and copper sulfate) are an economical source affording both sulfur and micronutrients.

Humectants have also been used to help retain water within the soil and plant tissue. These features make the incorporation of a humectant into a foliar fertilizer potentially beneficial to the needs of the plant.

Si applications with sugarcane have been discussed in detail in the publication, Savant, N. K, Korndorfer, G. H., Datnoff, L. E. and Snyder, G. H. 1999. Silicon Nutrition And Sugarcane Production: A Review, J. Plant Nutr. 22 (12):1853-1903 (Savant) which is incorporated by reference. Savant disclose the using silicate slag and calcium silicate slag as the source of Si for sugarcane.

Calcium silicate slag, a popular Si source, tends to have low solubility under high soil pH conditions. Growers have experimented with Ca-silicate slag applications for many years. This collective experience suggests that when soils test low for acetic acid extractable Si (less than 10 ppm in the soil extract), a 3 ton/Acre application of Ca-silicate slag will likely support favorable yield improvements over a three-crop cycle. A three-crop cycle is where the same crop is grown for three years. The Si source is generally broadcast applied and disked into the soil prior to planting.

Leaf Si analysis is very useful in combination with soil test Si values in determining the need for calcium silicate application.

Deficiency symptoms: Si deficiency is characterized by minute, circular white leaf spots (freckles). The freckling is more severe on older leaves. Older leaves may senesce prematurely, and the stools exhibit poor tillering and ratooning characteristics.

The philosophy that drives this is one identified by the American Society of Agronomists and is called the 4R's.

Right product

Right rate

Right timing

Right place

Current practices of adding silicon has been reduced to a soil amendment process and only applied prior to planting, (sugarcane is planted once in 3 years and yields three crops, one per year). This application requires 1-3 tons per acre every 3-4 years and in 2018 costs up to S200 per acre. Not only is this an expensive input, but one that runs contrary to the concept of the 4R's.

Agsorb® is a clay-based granules from Oil-Dri Corporation of America (Oil-Dri), has been used in the fertilizer industry as a fertilizer blend conditioning agent. Fertilizer salts by virtue of their properties absorb moisture and this phenomenon is exasperated when certain fertilizer materials are blended together and so the need for a conditioning agent. Agsorb® can mitigate the impact of excessive moisture in a blend, preserving manageable application properties of the blend for the grower. Agsorb® is granules that include Montmorillonite from Ripley Mississippi or from Mounds Illinois, Attapulgite from Ochlocknee Georgia, Hysrous Aluminosilicate from Taft, California. Below is the technical sheets for the above material from Oil-Dri shown in Tables 1 (granules) and Table 2 (powders).

TABLE 1
Granules

| | | | | | Liquid | Bulk |
|---|---|---|---|---|---|---|
| Production | | | Size Guide | Uniformity | Holding | Density |
| Location & | | | Number Ps | Index Ps | Capacity | Lbs/Ft³ |
| Mineral | Product | Process | 006.01.01 | 006.01.01 | Wt % E1521- | E1521-91 |
| Classification | Name | Options | (GSA) | (GSA) | 93 (ASTM) | (ASTM) |
| Ripley, MS | 30/60 | RVM | 40 | 50 | 31 | 37 |
| MONTMORILLONI1E | | | | | | |
| | 24/48 | LVM | 55 | 45 | 33 | 36 |
| | 16/30 | LVM | 85 | 50 | 33 | 36 |
| | 8/16 | LVM | 170 | 55 | 33 | 35 |
| | 5/20 | LVM | 215 | 25 | 33 | 35 |
| | 40/100 | LVM | ALPINE SIEVE PS | | 33 | 37.5 |
| | | | 006.01.01 (GSA) | | | |
| | | | 90%-325/+120 MESH | | | |
| Ochlocknee, GA | 24/48 | LVM | 55 | 40 | 35 | 32 |
| ATTAPULGITE | | | | | | |
| | 16/30 | RVM | 85 | 50 | 32 | 33 |
| | 16/30 | LVM | 85 | 50 | 35 | 32 |
| | 12/24 | LVM | 110 | 60 | 35 | 31 |
| | 8/16 | LVM | 170 | 55 | 35 | 31 |
| | 5/20 | LVM | 215 | 25 | 35 | 32 |
| Taft, CA | 24/48 | RVM | 55 | 40 | 27 | 39 |
| HYDROUS | | | | | | |
| ALUMINIOSILICA | | | | | | |
| | 16/30 | RVM | 85 | 50 | 27 | 38 |
| | 5/20 | RVM | 215 | 25 | 27 | 40 |

Granules

| | | Moisture | | | |
|---|---|---|---|---|---|
| Production | pH | Content | Particle | Attrition % | |
| Location & | In | Wt % | Count | Resistance | |
| Mineral | 001.01.01 | D2216-80 | E1520-93 | P-A 1056 B | Available |
| Classification | (ODC) | (ODC) | (ASTM) | (GSA) | Colors |
| Ripley, MS | 5 | 7 | 10.1 | 75-85 | GRAY |
| MONTMORILLONI1E | | | | | |
| | 5 | <3 | 8.6 | 85-90 | GRAY |
| | | | | | OR RED |
| | 5 | <3 | 1.6 | 85-90 | GRAY |
| | 5 | <3 | 0.4 | 85-90 | GRAY |
| | | | | | OR RED |
| | 5 | <3 | 0.5 | 85-90 | GRAY |
| | | | | | OR RED |
| | 5 | 1.5 | 18 | 85-90 | GRAY |
| | | | | | OR RED |
| Ochlocknee, GA | 6 | <3 | 9.0 | 80-90 | LIGHT |
| ATTAPULGITE | | | | | GRAY |
| | 7 | 12 | 1.8 | 75-85 | TAN |
| | 6 | <3 | 1.6 | 80-90 | LIGHT |
| | | | | | GRAY |
| | 6 | <3 | 0.9 | 80-90 | LIGHT |
| | | | | | GRAY |
| | 6 | <3 | 0.4 | 80-90 | LIGHT |
| | | | | | GRAY |
| | 6 | <3 | 0.6 | 80-90 | LIGHT |
| | | | | | GRAY |
| Taft, CA | 8 | <6 | 5.0 | 75-85 | TAN |
| HYDROUS | | | | | |
| ALUMINIOSILICA | | | | | |
| | 8 | <5 | 1.2 | 75-85 | TAN |
| | 8 | <5 | 0.4 | 75-85 | TAN |

TABLE 2
Powders

| Production | | | Alpine | Packed Bulk | | Moisture |
|---|---|---|---|---|---|---|
| Location & | | | Sieve | Density Lbs/Ft³ | pH In | Content Wt % |
| Mineral | Product | Process | Ps 006.01.01 | 23-Nf-18-Usp1 | 001.01.01 | D2216-80 |
| Classification | Name | Options | (GSA) | (USP) | (ODC) | (ODC) |
| Ochlocknee, GA | −325 | RVM | 80%-325 mesh | 43 | 7 | 15 |
| ATTAPULGITE | | | | | | |
| | −325 | LVM | 80%-325 mesh | 38 | 7 | 5 |
| | −325 | ULT | 80%-325 mesh | 37 | 6 | 3 |
| Mounds, IL | −325 | RVM | 80%-325 mesh | 43 | 5 | 10 |
| MONTMORILLONITE | | | | | | |
| | −325 | LVM | 80%-325 mesh | 40 | 5 | 3 |

In 2018, on the SDS sheets for Agsorb® had a 70% SiO₂ guarantee and thought that since it was already sized and designed to be added to blend granular fertilizer, what if we could render the crop required Si from this source?

Verge™ from Oil-Dri has a durable outer core that prevents tiny fragments from breaking off, unlike traditional, irregular-shaped granules that rub together during handling, transportation, and formulation. Verge™ technical specifications are shown in Table 3.

TABLE 3

| | LPHD | S | N |
|---|---|---|---|
| | disintegrating | Slow disintegrating | Non-disintegrating |
| density | 48.5 | 48 | 46 |
| dust index | <0.3 | <0.3 | <0.3 |
| hardness | 94 | 93 | 96 |
| liquid hold | 22 | 23 | 25 |
| capacity | | | |
| moisture | 5 | 6 | 2 |
| pH | 6 | 5 | 5 |
| | SGN 100 | SGN 140 | SGN 200 |
| mesh size | 16/30 | 12-20 | 8/16 |
| uniformity index | −60 | −60 | −60 |
| angle of repose | 27° | 25° | 25° |
| Granlues per lb. | −900 k/lb | −400 k/lb | −200 k/lb |

U.S. Patent Publication No. 2017/0360029, which is incorporated by reference, discloses a chemical agent for controlling soil nematode. In formulation example 5 uses attapuligite as a carrier.

U.S. Patent Publication No. 2013/0210624 ('624 publication) which is incorporated by reference, discloses granular material employed as a fungicide or a fertilizer or both, comprising phosphorous acid (H₃PO₃) or phosphite (which may include HPO₃), along with a metal and phosphate on a granular carrier; or a mixture of a phosphite product and a phosphate product, on a granular carrier; or mixture of a metal phosphite product and phosphate on a gramular carrier. The mixture may contain a chelated metal on a granular carrier. Another mixture includes a phosphite product on a first granular carrier, and a phosphate product on a second granular carrier wherein the two are mixed and the phosphite product and the phosphate product may or may not include a metal ion. Alternatively, the mixture may also contain a chelated metal on a third granular carrier.

The '624 publication discloses in paragraph no. [0054] clay-based granules such as that sold by Oil-Dri Corporation as Verge™ may be formulated to disintegrate at an extremely fast rate such as one minute, or to dissolve far more slowly into thousands of microparticles.

### SUMMARY OF THE INVENTION

It is an object of the invention to find Si source(s), preferably in granular form that could be added to an agriculture composition and can be applied to the ground surface. The agricultural composition can optionally contain a fertilizer, in particular to a granular fertilizer.

Another object is to apply the agriculture composition according to the invention containing the granular Si can be applied in a band or (starter) application, broadcast application or strip placement application. A band or starter application is the placement of the agricultural formation in the same area as the seed. A broadcast application is the general distribution of the agricultural composition over the entire soil surface. A strip placement is the placement of the agricultural composition in narrow strips. Crops will differ with placement and spacing. For example, spacing in sugarcane is 60″ and with multiple applications could be placed about 2″ to about 12″ at plant in the drill or placed on the soil surface with supplement applications after cane has been planted.

The agricultural composition that contains Si source then could be applied at the same time as other fertilizers. It can be applied in one application or multiple applications, such as, but not limited to: 2, 3, 4, 5, 6, etc. applications a year. By applying the agricultural composition would complement the concept of the 4R's, thereby maximizing input efficiencies, get better yields and quality and probably save the grower money.

An object of the invention was to be able to reduce the amount of fertilizer blends used on the fields and to save the grower's time from applying the product. Therefore, there would be less product placed on the fields and this would give the grower more time.

The advantages would be as follows:
The product can travel with all fertilizer blends thereby eliminating the soil amendment of 1-3 tons.
   This opens the door to evaluate for optimum timing and rates of Si for example with sugarcane which is fertilized 2-5 times annually.
   This opens the door to evaluate for optimum placement of Si in conjunction with the growth stage of the crop.
Instead of 1-3 tons per acre, equivalent Si input would only require about 250 to about 750 (respectively) pounds per acre with half the cost.
In conjunction with supplying Si to the crop, when applied at 750 lbs per acre into the planting drill, the absorbent properties of the product would serve to hold moisture around the seed-piece.

Another embodiment of the invention relates to a fertilizer composition comprising a fertilizer and Si clay granules wherein the Si clay granules are in an amount from about 10 to about 90% by weight based on the total amount of the fertilizer and Si clay.

The agricultural composition and the fertilizer composition according to the invention can contain acids such as organic or inorganic acids.

Inorganic acids, include mineral acids selected from the group consisting of nitric acid, phosphoric acid, sulfuric acid, and mixtures thereof; and phosphorous acid or ammonia or a mixture thereof or phosphorous acid and/or ammonia can also be used in combination with the mineral acids.

Organic acids are preferably fulvic acid, humic acid, citric acid and carboxylic acid, preferably C₁ to C₂₀ carboxylic acid.

Rendering of the “Si” into a plant available form, (SiO₂), is made possible by increasing acidity. To point, the acidity of the blend, even partner components inside the blend, that serve to reduce the pH of the soil within the placement zone of the fertilizer containing AgSorb, triggers the process of changing Siai (reserve Si and not plant available) to SiO₂.

The agricultural composition or fertilizer composition can contain micronutrients and macronutrients as discussed above in the background of the invention section of the application.

The invention also relates to a process of fertilizing a plant which comprises applying the fertilizer to the ground (soil).

The invention also relates to a process of treating a plant which comprises applying the agricultural composition according to the invention to the ground (soil).

An embodiment 1 of the invention is to a process of treating a plant which comprises applying an agricultural composition which comprises Si clay granules or powders wherein the composition is applied in an amount from about 150 pounds to about 4,000 pounds per acre.

Embodiment 2—The process as described in embodiment 1, wherein the composition is applied in an amount from about 250 to about 2000 pounds per acre.

Embodiment 3—The process as described in embodiment 1, wherein the composition is applied in an amount from about 250 to about 700 pounds per acre.

Embodiment 4—The process as described in embodiments 1, 2 or 3, wherein the composition further comprises A) an inorganic or organic salt or a mixture thereof,

B) a fertilizer,

C) a pH reducer,

D) macronutrients or

E) micronutrients

Embodiment 5.—The process as described in embodiments 1, 2, 3, or 4 , wherein the said inorganic or organic salt is present and is a mineral acid, phosphorous acid, ammonia, fulvic acid, humic acid, citric acid or carboxylic acid or mixtures thereof.

Embodiment 6—The process as described in any of the previous embodiments, wherein the said inorganic or organic salt is nitric acid, phosphoric acid, sulfuric acid, phosphorous acid, ammonia or a Ci to C20 carboxylic acid or mixture thereof.

Embodiment 7—The process as described in any of the previous embodiments, wherein the pH reducer is present and is an organic acid.

Embodiment 8—The process as described in any of the previous embodiments, wherein the micronutrient is present and is a water soluble salt of boron, iron, manganese, magnesium, copper or zinc.

Embodiment 9—The process as described in any of the previous embodiments wherein composition is applied to the ground by a band application, broadcast application or strip placement application.

Embodiment 10—The process as described in any of the previous embodiments, wherein composition is applied within 30 days after the ground has been fertilized.

Embodiment 11—The process as described in any of the previous embodiments, wherein said Si clay granules or powders are present in the agricultural composition in an amount from about 10% to about 90% by weight based on the amount of the composition.

Embodiment 12—The process as described in any of the previous embodiments, wherein said Si clay granules or powders are present in the agricultural composition in an amount from about 40% to about 60% by weight based on the amount of the composition.

Embodiment 13—The process as described in any of the previous embodiments, wherein said Si clay granules or powders are present in the agricultural composition in an amount from about 40% to about 60% by weight based on the amount of the composition.

Embodiment 14—The process as described in any of the previous embodiments, wherein the Si clay is Attapulgite, Montmorillonite or aluminosilcate or a mixture thereof.

Embodiment 15—The process as described in any of the previous embodiments, wherein the plant is grass crops, turf crops, cucurbit crops, brassica crops, solanaceae crops, bush berries, citrus, stone fruits, nuts apples, avocado, mangos, lychee or olives.

Embodiment 16—The process as described in any of the previous embodiments, wherein the plant is barley, maize, oats, rice, rye, sorghum, wheat, millet, sugar cane or bamboo, Bermuda grass, St. Augustine grass, Zoysia grass, Kentucky bluegrass, Perennial ryegrass, pumpkin, squash, zucchini, cucumber, watermelon, gourd, cabbage, cauliflower, broccoli, mustard, brussel sprouts, turnips/turnip greens, collards, kale, boy choy, tomatoes, tomatillos, eggplant, potatoes, goji berries, tobacco, peppers, sugarcane rice, strawberry, blueberry, blackberry, raspberry, mulberry, elderberry, red currants, white currants, black currents, citron, clementine, grapefruit, oranges, sudachi, shonan gold, satsuma, tangelo, tangerine, limetta, tangor, lemons, limes, citron, yuzu or ugli fruit, peaches, nectarines, plums, peanut, almond, apples, avocado, mangos, lychee or olives.

### A BRIEF DESCRIPTION OF THE FIGURES

FIG. 1 illustrates 21 tissue samples over a 15 month period using Agsorb Silicon (AgSi) compared to cony.

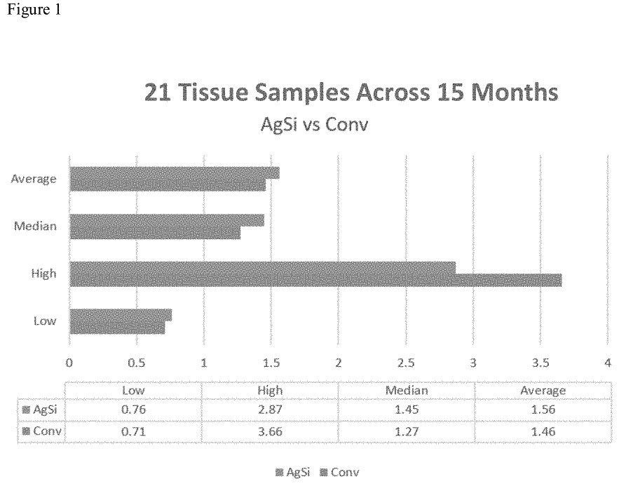

FIG. 2 illustrates the same 21 tissue samples over a 15 month period using AgSi compared to conv. as shown if FIG. 1. FIG. 2 illustrates the optimum silicon lever in sugarcane is 0.6% and above and the critical Si levels are below 0.5%. FIG. 2 represents one set of field trials with a duration from plant through the current crop stage.

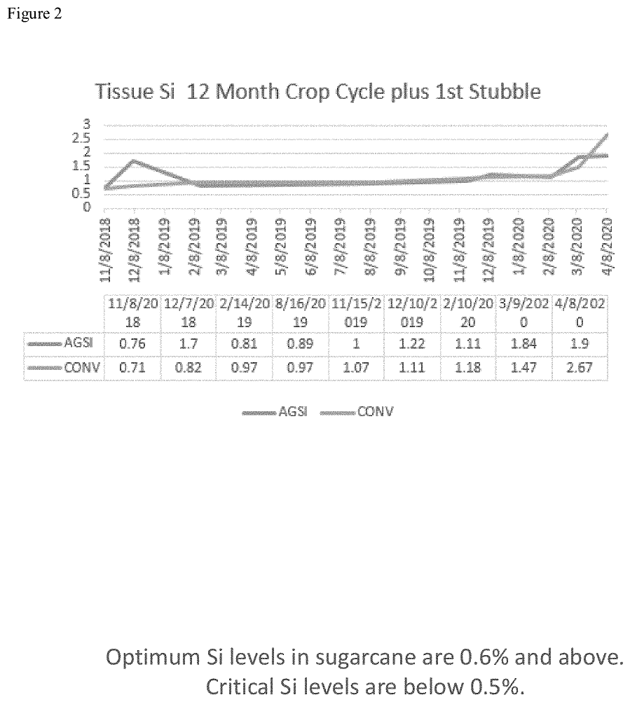

FIG. 3 illustrates the dis-solution of SiO₂ over a five month period.

FIG. 4 illustrates the average dis-solution (DSS) of SiO₂ over the same five month period as shown in FIG. 3.

FIG. 5 illustrates the dis-solution of Mn over the same five month period as shown in FIG. 3.

FIG. 6 illustrates the dis-solution of K20 over the same five month period as shown in FIG. 3.

### A DETAILED DESCRIPTION OF THE INVENTION

The invention relates to an agricultural composition comprising Si clay granules which can be applied to the soil in an in an amount from about 150 pounds to about 4,000 pounds per acre, preferably about 250 pounds to about 2,000 pounds per acre and ever more preferably from about 300 pounds to about 750 pounds per acre and most preferably about 400 pounds to about 700 pounds per acre. The agricultural composition can be applied after the soil has been fertilized. Preferably, the first application would be less than 90 days after the soil has been fertilized, preferably less than 60 days, and more preferably less than 30 and most preferably less 15 days. The agricultural composition can be also applied in more than one applications (multiple applications) for the planting cycle. For example, the agricultural composition can be applied in at least 1, 2, 3, 4, 5, 6, 7 or 8 applications.

The agricultural composition preferably contains either organic and/or inorganic salts.

The agricultural composition can also contain a fertilizer. The agricultural composition also does not require a fertilizer and exclude a fertilizer.

The invention relates to a fertilizer composition comprising a fertilizer and Si clay granules wherein the Si clay is an amount from about 10 to about 90% by weight based on the total amount of the fertilizer and Si clay.

The fertilizer composition can be used for plants such as, but not limited to grass crops, turf crops, cucurbit crops, brassica crops, solanaceae crops, bush berries, citrus, stone fruits, nuts or other crops.

Grass crops include but are not limited to barley, maize (corn), oats, rice, rye, sorghum, wheat, millet, sugar cane or bamboo.

Turf crops include but are not limited to Bermuda grass, St. Augustine grass, Zoysia grass, Kentucky bluegrass or Perennial ryegrass.

Cucurbit crops include but are not limited to pumpkin, squash, zucchini, cucumber, watermelon or gourd.

Brassica Crops include but are not limited to cabbage, cauliflower, broccoli, mustard, brussel sprouts, turnips/turnip greens, collards, kale or bok choy.

Solanaceae crops include but are not limited to tomatoes, tomatillos, eggplant, potatoes, goji berries, tobacco, peppers (bell peppers, chili peppers, paprika, tamales, tomatillos, pimentos, cayenne, etc).

Bush berries, such as, but not limited to, strawberry, blueberry, blackberry, raspberry, mulberry, elderberry, red currants, white currants, and black currents.

Citrus, such as, but not limited to, citron, clementine, grapefruit, oranges, sudachi, shonan gold, satsuma, tangelo, tangerine, limetta, tangor, lemons, limes, citron, yuzu or ugli fruit.

Stone fruits, such as, but not limited to peaches, nectarines and plums would also work.

Nuts, such as, but not limited to peanut and almond would also work.

Other crops such as, but not limited to apples, avocado, mangos, lychee and olives.

The fertilizer can be any fertilizer such as a fertilizer containing Nitrogen, Phosphorous and potassium (K) referred to as “NPK” or a fertilizer which does not contain any nitrogen referred to as a XPK. The fertilizer contain boron, zinc, copper, iron, blends of nitrogen phosphorous and potash or mixtures thereof.

The fertilizer can be ammonia sulfate, an ammonia salt of a carboxylic acid, mono- or di-potassium phosphate, a micronutrient, ammonia nitrate, urea, ammonia citrate or ammonia acetate.

The Si clay can be any Si clay. The Si clay is preferably, Agsorb® which is granules that include Montmorillonite from Ripley Mississippi or from Mounds Illinois, Attapulgite from Ochlocknee Georgia, Hydrous Aluminosilicate from Taft, California and Verge™ also from Oil-Dri.

Prior to the invention it was known to use a conditioner such as Si clay up to 100 pounds per ton fertilizer. I have found that it is much better to increase the amount of Si clay and it should be in an amount from about 200 to about 1800 pounds to the ton fertilizer. Another words the amount of the Si clay is from about 10% by weight to about 90% by weight, and preferably from 20 to 60% by weight and most preferably 40 to 60% weight of the total weight of fertilizer and Si.

Optional components can be pH reducer and micronutrients.

A pH reducer can be used to lower the pH of the fertilizer composition would be greater than 10, preferably about 12. The pH reducer can be any acid such as an organic acid, such as but not limited to citric acid or carboxylic acid or Essence 6 from Helena Agri-Enterprises LLC (Helena). Essence 6 is a concentrated organic acid complex. Its low pH, clear amber liquid formulation will also clear drip irrigation lines. Essence 6 contains Helena's NutrAsyst Formulation Technology (NFT), a high quality blend of organic acids that is designed to improve the performance of liquid fertilizers. About 2 quarts per acre.

The composition can contain micronutrients such as, but not limited to a water soluble salt of boron, iron, manganese, magnesium, copper or zinc.

The fertilizer composition according to the invention should be applied to the soil in an amount from about 150 pounds to about 4,000 pounds per acre, preferably about 250 pounds to about 2,000 pounds per acre and ever more preferably from about 300 pounds to about 750 pounds per acre and most preferably about 400 pounds to about 700 pounds per acre.

Sugarcane fertilization requires around 600 pounds of custom fertilizer at planting and 200-300 pounds 3-5 times through the crop cycle (12 months). I was able to incorporate this SiO2 product with the fertilizer blend in any of these application slots and therefore take advantage of the timing and rate piece of the input strategy.

### EXAMPLES

Two examples were made with one example using a first sample according to the invention using Agsorb® and the second example with a calcium silicate slag. I compared the results and evaluated with respect to Si. The results are as shown in Table 4 below:

TABLE 4
Neither examples 1 or 2 contain fertilizer.

| Example 1 according to the | |
|---|---|
| invention contains non-treated | |
| AgSorb | |
| Calcium | 1.49% |
| Magnesium (Total) | 2.22% |
| Magnesium (Water Soluble) | 0.05% |
| Aluminum | 2.61% |
| Total Silicon | 41.20% |
| Extractable Silicon Mehlich 3 (M3) | 1449.42 ppm |
| SiO₄ | |
| Example 2 using calcium silicate | |
| slag | |
| Calcium | 23.40% |
| Magnesium (Total) | 2.16% |
| Magnesium (Water Soluble) | 0.01% |
| Aluminum | 1.74% |
| Total Silicon | 4.12% |
| Extractable Silicon Mehlich 3 (M3) | 832.46 ppm |
| SiO₄ | |

W = Wet (as received) BASIS

Two samples of each, were evaluated as a fertilizer source and the Agsorb® rendered 10× available SiO₂ than the slag source. In addition to that, I evaluated each source for soluble Si as well and the Agsorb® had 50% more soluble (immediately available) Si.

I checked two samples of each product using 50 grams of each product was added to 200 ml of distilled water for 30 day with random, equivalent agitation. Samples were evaluated as a fertilizer. Filtrate is the solid caught in 50 micron filter, water soluble is the liquid that passed through the filter Slag. The results are shown in Table 5 below:

TABLE 5

| | Water solubable | Filtrate: | Raw: |
|---|---|---|---|
| | SiO2 | Total SiO2 | Total SiO2 |
| Agsorb | 1.99% | 37.05% | 47.05% |
| Slag | 1.43% | 5.93% | 4.90% |

Two examples were made with one example using a first sample according to the invention using Agsorb0 and the second example with a calcium silicate slag. I compared the results and evaluated with respect to Si. 2 examples with the agricultural composition containing slag and three containing AgSorb on different fields containing a different amount of acreage as shown in Tables 6 and 7 below. The chemical make-up of these examples 1 (according to the invention contains non-treated AgSorb) and example 2 (using calcium silicate slag) are shown above in Table 4.

TABLE 6
Slag

| Harv | Harv | | | | |
|---|---|---|---|---|---|
| Total | Total | Harv | Percent | Percent | Lbs Sug |
| Acres | Tons | TPA | Sucrose | Yield | Per Acre |
| 67.38 | 4,005.48 | 59.45 | 14.49 | 11.64 | 13,843 |
| 63.99 | 3,908.08 | 61.07 | 14.34 | 11.48 | 14,022 |
| 74.57 | 4,530.39 | 60.75 | 14.32 | 11.26 | 13,679 |
| 71.53 | 4,301.86 | 60.14 | 14.18 | 11.16 | 13,454 |
| 68.39 | 4,060.99 | 59.38 | 14.82 | 11.66 | 13,877 |
| 345.86 | 20,806.80 | 60.16 | 14.43 | 11.45 | 13775 |

TABLE 7
AgSorb

| Harv | Harv | | | | |
|---|---|---|---|---|---|
| Total | Total | Harv | Percent | Percent | Lbs Sug |
| Acres | Tons | TPA | Sucrose | Yield | Per Acre |
| 72.63 | 4,298.89 | 59.19 | 14.40 | 11.49 | 13,606 |
| 70.51 | 4,342.06 | 61.58 | 14.11 | 11.17 | 13,755 |
| 69.45 | 4,185.25 | 60.26 | 14.12 | 11.10 | 13,378 |
| 212.59 | 12,826.20 | 60.33 | 14.21 | 11.25 | 13580 |

It is noted that the last line of table 6 and 7 which appear below the line are a total for harvested total acres and harvest total tons. However, the next four columns, Harvest tons per acre (TPA) Percent Sucrose, Percent Yield and pounds (lbs) Sugar (Sug) per acre are the average for each of the columns. The AgSorb (AgSi) is delivering equivalent yields as a Si source compared to conventional. Cost/acre is more economical and logistically easier to apply.

The following is yield data shown in Table 8 from other field demonstrations using AsSorb (AgSi) versus conventional treatment (using slag).

TABLE 8

| | AgSi | | | | Conventional treatment (slag) | | | |
|---|---|---|---|---|---|---|---|---|
| | Harv Total | Harv Total | Lbs Sug | Harv | Harv Total | Harv Total | Lbs Sug | Harv |
| | Acres | Tons | Per Acre | TPA | Acres | Tons | Per Acre | TPA |
| | 12.28 | 704.14 | 12,380 | | 12.78 | 794.75 | 13,691 | |
| | 7.99 | 640.03 | 17,608 | | 12.60 | 625.51 | 10,669 | |
| | 10.79 | 632.47 | 12,795 | | 8.66 | 600.99 | 15,337 | |
| | 9.20 | 624.46 | 16,228 | | 9.50 | 674.46 | 15,550 | |
| | 7.27 | 561.64 | 17,407 | | 6.92 | 529.37 | 16,975 | |
| | 7.62 | 483.13 | 14,772 | | 7.67 | 551.92 | 15,808 | |
| | 7.76 | 479.28 | 13,984 | | 7.87 | 537.34 | 14,534 | |
| | 7.95 | 457.05 | 12,759 | | 5.75 | 478.00 | 17,426 | |
| | 7.49 | 451.50 | 14,306 | | | | | |
| | 7.95 | 618.68 | 17,059 | | | | | |
| Total | 86.30 | 5,652.38 | 149,298 | 65.50 | 71.75 | 4,792.34 | 119,990 | 66.79 |

Of all samples taken, highest, lowest and average results were extracted and tabled. Highest number not relative to yield. Leaf levels need to remain above 6% to be sufficient for Si.

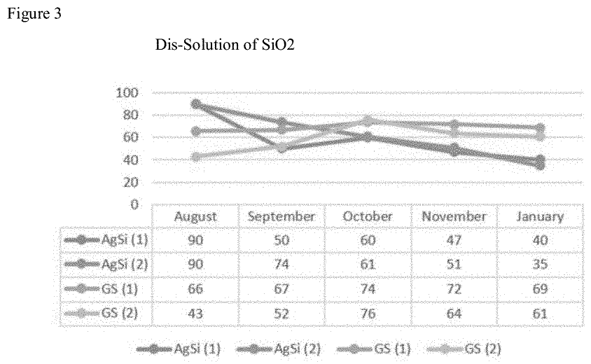

I checked samples using 50 grams of the treated material and added 200 ml of distilled water and allow it to hydrolysis to act upon the material over time. As a part of the procedure, the treatment would be shaken well 2 to 3 times per week with 4 to 5 weeks the period between samples. All the samples were treated the same. Samples (25 ml) were drawn form the clear solution part of the treatment evaluation, then replaced with 25 ml of distilled water in order to initiate the next step of the DDS. Samples were evaluated for the SiO2 (available silicon, manganese and potassium). The results are shown in FIGS. 3, 4, 5 and 6.

Ag(1) and Ag(2) are the same composition as example 1 above disclosed in table 4. GS (1) and GS (2) are the same composition as disclosed for example 2 using calcium silicate slag. This is also referred to as conventions. There are 2 reps for each composition.

FIG. 3 illustrates an advantage of the dis-solution of SiO2. Since the inventive composition requires a higher amount of SiO2 compared to the prior art. GS (1) and GS (2). The amount of SiO2 in AgSi(1) and AgSi (2) starts at 90 in August and in January is less than half (40 and 35). The dis-solution of GS (1) and (2) does not occur. The SiO2 for GS (1) in August is 66 and the amount of SiO2 increases 5 months later in January to 69. The SiO2 for GS (2) in August is 43 and the amount of SiO2 increases 5 months later in January to 61. The goal is to render sufficient soluble Si in the soil profile for plant availability and to maintain a leaf level Si not to be less than 0.6%. The dissolution test is not soil content related.

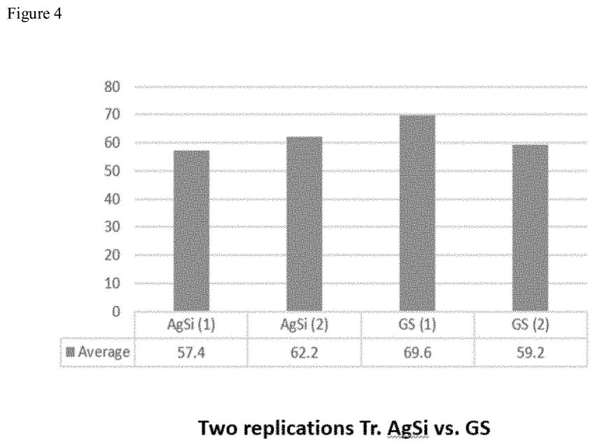

FIG. 4 shows the average dissolution (DDS) SiO2 from August through January. FIG. 4 shows sufficient release of Si from the clay particle that is a soluble source of Si for the crop. In FIG. 4, the abbreviation for Tr. AgSi is treated AgSorb and GS again is example 2 (using calcium silicate slag).

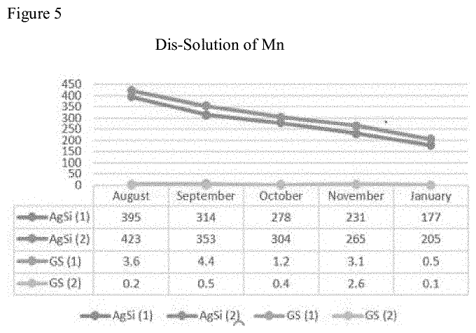

FIG. 5 illustrates an advantage of the dis-solution of Mn where GS1 and GS (2) are almost identical and are substantially lower than that of AgSi(1) and AgSi(2). The content of manganese (Mn) reduces over time. However, according to the composition of invention although Mn reduces over time (from August to January—after 5 months) there is a high range of Mn from 177 to 205 remaining in the soil. However, the GS (1) and GS(2) only start at 3.6 and 0.2 for the Mn and after the same time period reduce to only 0.5 to 0.1 respectively. There is not nearly as much manganese remaining in the soil using GS (1) and GS (2). The composition according to the invention has a significantly higher amount of manganese remaining in the soil. This is due to the treatment of complex acids applied to AgSi.

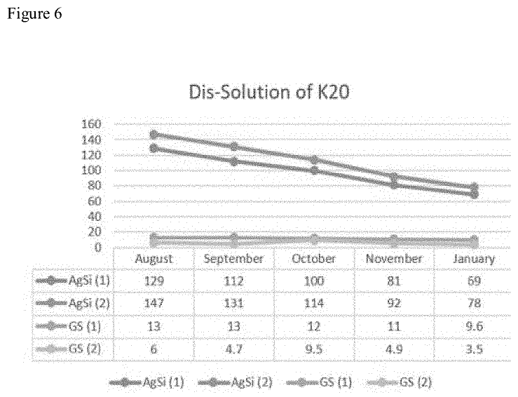

FIG. 6 illustrates an advantage of the dis-solution of K20 where GS1 and GS (2) are almost identical and are substantially lower than that of AgSi (1) and AgSi(2). The content of K20 reduces over time. However, according to the composition of invention reduces over time (from August to January—after 5 months) there is a range of potassium from 69 to 78 (K20) remaining in the soil. However, the GS (1) and GS(2) only start at 13 and 6 for the K20 and after the same time period reduce to only 3.5 to 9.6 respectively. There is not nearly as much potassium remaining in the soil using GS (1) and GS (2). The composition according to the invention has a significantly higher amount of potassium remaining in the soil.

All ranges disclosed herein are inclusive of the endpoints, and the endpoints are independently combinable with each other (e.g., ranges of “10% to 90%, is inclusive of the endpoints and all intermediate values of the ranges of “10 to 90 ” etc.). “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All the references described above are incorporated by reference for all useful purposes.

I claim:

1. A process of treating a plant which comprises applying an agricultural composition which comprises Si clay granules or powders wherein the composition is applied in an amount from about 150 pounds to about 4,000 pounds per acre.

2. The process as claimed in claim 1, wherein the composition is applied in an amount from about 250 to about 2000 pounds per acre.

3. The process as claimed in claim 1, wherein the composition is applied in an amount from about 250 to about 700 pounds per acre.

4. The process as claimed in claim 1, wherein the composition further comprises
A) an inorganic or organic salt or a mixture thereof,
B) a fertilizer,
C) a pH reducer,
D) macronutrients or
E) micronutrients

5. The process as claimed in claim 4, wherein the said inorganic or organic salt is present and is a mineral acid, phosphorous acid, ammonia, fulvic acid, humic acid, citric acid or carboxylic acid or mixtures thereof.

6. The process as claimed in claim 5, wherein the said inorganic or organic salt is nitric acid, phosphoric acid, sulfuric acid, phosphorous acid, ammonia or a C₁ to C₂₀ carboxylic acid or mixture thereof.

7. The process as claimed in claim 4, wherein the pH reducer is present and is an organic acid.

8. The process as claimed in claim 4, wherein the micronutrient is present and is a water soluble salt of boron, iron, manganese, magnesium, copper or zinc.

9. The process as claimed in claim 3, which further comprises
A) an inorganic or organic salt or a mixture thereof,
B) a fertilizer,
C) a pH reducer,
D) macronutrients or
E) micronutrients

10. The process as claimed in claim 9, wherein the said inorganic or organic salt is present and is nitric acid, phosphoric acid, sulfuric acid, phosphorous acid, ammonia or a C₁ to C₂₀ carboxylic acid or mixture thereof.

11. The process as claimed in claim 1, wherein composition is applied to the ground by a band application, broadcast application or strip placement application.

12. The process as claimed in claim 1, wherein composition is applied within 30 days after the ground has been fertilized.

13. The process as claimed in claim 10, wherein composition is applied within 30 days after the ground has been fertilized.

14. The process as claimed in claim 4, wherein said Si clay granules or powders are present in the agricultural composition in an amount from about 10% to about 90% by weight based on the amount of the composition.

15. The process as claimed in claim 4, wherein said Si clay granules or powders are present in the agricultural composition in an amount from about 40% to about 60% by weight based on the amount of the composition.

16. The process as claimed in claim 9, wherein said Si clay granules or powders are present in the agricultural composition in an amount from about 40% to about 60% by weight based on the amount of the composition.

17. The process as claimed in claim 1, wherein the Si clay is Attapulgite, Montmorillonite or aluminosilcate or a mixture thereof.

18. The process as claimed in claim 1, wherein the plant is grass crops, turf crops, cucurbit crops, brassica crops, solanaceae crops, bush berries, citrus, stone fruits, nuts apples, avocado, mangos, lychee or olives.

19. The process as claimed in claim 1, wherein the plant is barley, maize, oats, rice, rye, sorghum, wheat, millet, sugar cane or bamboo, Bermuda grass, St. Augustine grass, Zoysia grass, Kentucky bluegrass, Perennial ryegrass, pumpkin, squash, zucchini, cucumber, watermelon, gourd, cabbage, cauliflower, broccoli, mustard, brussel sprouts, turnips/turnip greens, collards, kale, bok choy, tomatoes, tomatillos, eggplant, potatoes, goji berries, tobacco, peppers, sugarcane rice, strawberry, blueberry, blackberry, raspberry, mulberry, elderberry, red currants, white currants, black currents, citron, clementine, grapefruit, oranges, sudachi, shonan gold, satsuma, tangelo, tangerine, limetta, tangor, lemons, limes, citron, yuzu or ugh fruit, peaches, nectarines, plums, peanut, almond, apples, avocado, mangos, lychee or olives.

20. The process as claimed in claim 16, wherein the plant is barley, maize, oats, rice, rye, sorghum, wheat, millet, sugar cane or bamboo, Bermuda grass, St. Augustine grass, Zoysia grass, Kentucky bluegrass, Perennial ryegrass, pumpkin, squash, zucchini, cucumber, watermelon, gourd, cabbage, cauliflower, broccoli, mustard, brussel sprouts, to greens, collards, kale, bok choy, tomatoes, tomatillos, eggplant, potatoes, goji berries, tobacco, peppers, sugarcane rice, strawberry, blueberry, blackberry, raspberry, mulberry, elderberry, red currants, white currants, black currents, citron, clementine, grapefruit, oranges, sudachi, shonan gold, satsuma, tangelo, tangerine, limetta, tangor, lemons, limes, citron, yuzu or ugh fruit, peaches, nectarines, plums, peanut, almond, apples, avocado, mangos, lychee or olives.
